(19) United States
(12) Patent Application Publication
(10) Pub. No.: US 2018/0108465 A1
(43) Pub. Date: Apr. 19, 2018

(54) MAGNETIC POWDER AND PRODUCTION METHOD THEREOF, MAGNETIC CORE AND PRODUCTION METHOD THEREOF, AND COIL COMPONENT

(71) Applicant: Murata Manufacturing Co., Ltd., Kyoto (JP)

(72) Inventor: Toru TAKAHASHI, Nagaokakyo-shi (JP)

(73) Assignee: Murata Manufacturing Co., Ltd., Kyoto (JP)

(21) Appl. No.: 15/844,929

(22) Filed: Dec. 18, 2017

Related U.S. Application Data
(63) Continuation of application No. PCT/JP2016/066745, filed on Jun. 6, 2016.

(30) Foreign Application Priority Data
Jun. 19, 2015 (JP) 2015-123507

(51) Int. Cl. H01F 1/147; B22F 9/08; B22F 1/00; B22F 9/00; C22C 45/02; C22C 38/32; C22C 38/02; C22C 38/00; H01F 41/02; H01F 27/255; H01F 27/28

(52) U.S. Cl. CPC H01F 1/14766; B22F 9/082; B22F 1/0007; B22F 9/008; C22C 45/02; C22C 38/32; B22F 2301/35; C22C 38/002; H01F 41/02; H01F 27/255; H01F 27/28; B22F 2009/0828; B22F 2304/10; C22C 38/02

(57) ABSTRACT

A magnetic powder contains at least the first alloy powder and the second alloy powder in which those composition are different. The second alloy powder has a smaller median diameter than the first alloy powder and contains Cr of 0.3-14 at %. The first alloy powder has a Cr content of 0.3 at % or less. With respect to the total sum of the first alloy powder and the second alloy powder, a content of the second alloy powder is 20-50 vol % and the ratio of the median diameter of the first alloy powder to the second alloy powder is 4-20. The first alloy powder comprises either an amorphous phase or a crystalline phase having an average crystallite size of 50 nm or smaller. Thereby, a magnetic powder having low magnetic loss and good corrosion resistance without damaging insulation resistance and saturation magnetic flux density can be realized.

### CROSS REFERENCE TO RELATED APPLICATIONS

This application is a continuation application of international patent application Serial No. PCT/JP2016/066745 filed Jun. 6, 2016, which published as PCT Publication No. WO2016/204008 on Dec. 22, 2016, which claims benefit of Japan patent application No. 2015-123507 filed Jun. 19, 2015, the entire content of which are incorporated herein by reference.

### TECHNICAL FIELD

The present disclosure relates to a magnetic powder and a production method thereof, a magnetic core and a production method thereof, and a coil component, and more particularly to an alloy-based magnetic powder suitable for coil components such as a transformer and an inductor and a production method thereof, a magnetic core using the magnetic powder and a production method thereof, and a variety of coil components using the magnetic powder such as a reactor and an inductor.

### BACKGROUND

In coil components used for a power inductor, a transformer or the like, magnetic powders including metallic magnetic are widely used.

Particularly, amorphous alloys of these magnetic powder have been, conventionally, researched and developed actively because it has excellent soft magnetic characteristics, and further inductors using this kind of magnetic powders have also been developed.

For example, JP 2010-118486 A attempts to obtain an inductor that has a magnetic core and a coil arranged inside the magnetic core, in which the magnetic core contains a substance obtained by solidifying a mixture of an insulating material and a mixed powder composed of 90 to 98 mass % of an amorphous soft magnetic powder and 2 to 10 mass % of a crystalline soft magnetic powder, and the amorphous soft magnetic powder is represented by the general formula (Fe₁₋ₐTMₐ)_{100-w-x-y-z}P_{w}BₓL_{y}Si_{z} (provided that, inevitable impurities are contained, TM is one or more selected from Co and Ni, L is one or more selected from the group consisting of Al, V, Cr, Y, Zr, Mo, Nb, Ta, and W, and 0≤a≤0.98, 2≤w≤16 atomic % (hereinafter, referred as to “at %”), 2≤x≤16 at %, 0<y≤10 at %, 0≤z≤8 at %).

In JP 2010-118486 A, the main component of the magnetic core is formed by a mixed powder of crystalline soft magnetic powder and amorphous soft magnetic powder prepared so that the content of the crystalline soft magnetic powder is 2 to 10 mass %. The amorphous soft magnetic powder has a relatively large average particle diameter (for example, median diameter D₅₀: 10 μm), and thereby good inductance and low magnetic loss are ensured. In addition, the crystalline soft magnetic powder has a smaller average particle diameter (for example, median diameter D₅₀: 1 to 5 μm) than that of the amorphous soft magnetic powder, and thereby the filling property of the mixed powder is improved to enhance the magnetic permeability and furthermore the amorphous soft magnetic powders are bound to each other to improve a magnetic coupling force between the particles.

Further, in JP 2010-118486 A, since the amorphous soft magnetic powder is prepared by a water atomization method, the surface of the magnetic powder may be corroded. For this reason, the specific elements L each having corrosion resistance such as Al, V, and Cr are contained in the amorphous soft magnetic powder in the range of 10 at % or less, and thereby the occurrence of surface corrosion is suppressed.

JP 2001-196216 A attempts to obtain a powder magnetic core that, in a powder magnetic core obtained by mixing a powder A consisting of an amorphous soft magnetic alloy and a soft magnetic alloy fine powder B, and subjecting the mixture to compression molding, a mode of the particle size distribution of the powder A is five times or more than that of the powder B, and a volume percentage of the powder B to the total sum of volumes of the powder A and the powder B is 3% to 50%.

In JP 2001-196216 A, an amorphous soft magnetic alloy powder A having Fe as a main component and having a large particle size mode (for example, 53 μm) and an amorphous magnetic alloy fine powder B having a small particle size mode (for example, 6.7 μm) adding Cu, Nb, B, Si, or the like to Fe—Al—Si or Fe are mixed in a predetermined volume ratio, and the resulting mixture is subjected to molding processing at a large pressure of 500 to 1500 MPa to obtain a powder magnetic core.

### SUMMARY

However, in JP 2010-118486 A, the specific elements L such as Al, V, and Cr are contained in the amorphous soft magnetic powder in the range of 10 at % or less, and thereby the surface corrosion that can be caused by the water atomization method is suppressed, but each of these specific elements L is a nonmagnetic metal element, and therefore, the saturation magnetic flux density is lowered, resulting in the deterioration of magnetic characteristics.

Further, in JP 2001-196216 A, although a Fe—Al—Si-based material is used as the amorphous soft magnetic alloy powder A, while the Fe—Al—Si-based material has a good corrosion resistance, a brittleness is inferior, and therefore, the powder tends to be destroyed when carrying out the molding processing. For this reason, for example, when the Fe—Al—Si-based material is used for a high-frequency inductor or the like, it is difficult to ensure sufficient magnetic characteristics. On the other hand, a material system in which Fe contains an additive element such as Cu, Nb, B or Si is inferior in corrosion resistance and easily rusts, so that it may cause lowering in insulation resistance.

The present disclosure has been made in view of such a situation, and it is an object of the present disclosure to provide an alloy-based magnetic powder that has low magnetic loss and good corrosion resistance without damaging insulation resistance and saturation magnetic flux density and a production method thereof, a magnetic core using the magnetic powder and a production method thereof, and a variety of coil components using the magnetic powder. A magnetic alloy powder having a large average particle diameter contributes to improvement of magnetic characteristics such as improvement in saturation magnetic flux density and reduction in magnetic loss. It is thought that, by mixing the above-magnetic powder having the large average particle diameter with a magnetic powder having a small average particle diameter to form a mixed powder, the filling property of the magnetic powder can be improved, and thereby the magnetic coupling between the particles is facilitated and further improvement of the magnetic characteristics can be achieved.

Thereupon, the present inventor has made studies using an alloy powder having a large average particle diameter and an alloy powder having a small average particle diameter in which those composition are different from each other, and has found that a magnetic powder that has low magnetic loss and good corrosion resistance without damaging insulation resistance and saturation magnetic flux density can be obtained by controlling the Cr content, mixing ratio and average particle diameter ratio of these two kinds of alloy powders to fall within the predetermined range. Furthermore, the present inventor has also found that even when the alloy powder having the large average particle diameter includes not only an amorphous phase but also a crystalline phase having an average crystallite size of 50 nm or less, the same effect as in the amorphous phase can be obtained.

The present disclosure has been made based on such findings, and a magnetic powder according to the present disclosure contains a plurality of kinds of alloy powders including at least a first alloy powder and a second alloy powder in which those composition are different, in which the second alloy powder has an average particle diameter smaller than an average particle diameter of the first alloy powder and contains Cr in a range of 0.3 to 14 at % in terms of atomic ratio; a content of Cr of the first alloy powder is 0.3 at % or less in terms of atomic ratio; with respect to a total sum of the first alloy powder and the second alloy powder, a content of the second alloy powder is 20 to 50 vol % in terms of volume ratio; a ratio of the average particle diameter of the first alloy powder to the average particle diameter of the second alloy powder is 4 to 20; and the first alloy powder includes at least any one of an amorphous phase and a crystalline phase having an average crystallite size of 50 nm or less.

Herein, the above-mentioned average particle diameter means a cumulative 50% particle diameter D₅₀, and hereinafter, referred to as “median diameter” in the present disclosure. Further, in the magnetic powder of the present disclosure, the first alloy powder preferably contains a Fe—Si—B—P-based material as a main component.

Furthermore, in the first alloy, a part of Fe in the Fe—Si—B—P-based material is also preferably substituted with any one element of Ni and Co in a range of 12 at % or less, or a part of Fe in the Fe—Si—B—P-based material is also preferably substituted with Cu in a range of 1.5 at % or less, or further a part of B in the Fe—Si—B—P-based material is also preferably substituted with C in a range of 4 at % or less. Thereby, it is possible to obtain a magnetic powder suitable for various coil components that has good corrosion resistance and low magnetic loss and is capable of energization of large current.

Furthermore, in the magnetic powder of the present disclosure, the first alloy powder is preferably prepared by a gas atomization method. By preparing the first alloy powder contributing to the improvement of the magnetic characteristics with the gas atomization method capable of suppressing mixing of impurities, it is possible to obtain the first alloy powder having a high saturation magnetic flux density and high quality in a spherical shape.

Further, in the magnetic powder of the present disclosure, the second alloy powder may include either an amorphous phase or a crystalline phase. In the magnetic powder of the present disclosure, the second alloy powder preferably contains a Fe—Si—Cr-based material as a main component.

A Fe—Si—Cr based material has good toughness as compared with a Fe—Al—Si-based material, so that it is excellent in processability. Further, the Fe—Si—Cr-based material contains a predetermined amount of Cr, so that it can ensure corrosion resistance. Accordingly, it is possible to yield a magnetic powder having good insulation resistance and magnetic characteristics in combination with the action of the first alloy powder. Furthermore, in the second alloy powder, the Fe—Si—Cr-based material preferably contains at least one element selected from the group consisting of B, P, C, Ni, and Co.

In the magnetic powder of the present disclosure, it is preferred that the second alloy powder is prepared by a water atomization method. By preparing the second alloy powder containing Cr with the water atomization method capable of high pressure spraying, it is possible to easily obtain the second alloy powder having a smaller median diameter than the first alloy powder and having a corrosion resistance function.

That is, a method for producing a magnetic powder according to the present disclosure is the method containing at least a first alloy powder and a second alloy powder in which those composition and median diameter are different, in which a step of preparing the first alloy powder includes a first mixing step of weighing and mixing predetermined base materials, a first heating step of heating the mixed product to prepare a molten metal, and a first spraying step of spraying an inert gas on the molten metal to pulverize the molten metal and to prepare an amorphous powder; a step of preparing the second alloy powder includes a second mixing step of weighing and mixing predetermined base materials containing Cr so as to contain the Cr in a range of 0.3 to 14 at % in terms of atomic ratio, a second heating step of heating the mixed product to prepare a molten metal, and a second spraying step of spraying water on the molten metal to pulverize the molten metal and to obtain a second alloy powder in which a median diameter ratio between a median diameter of the first alloy powder and a median diameter of the second alloy powder is 4 to 20; the amorphous powder is used as the first alloy powder, and the first alloy powder and the second alloy powder are mixed so that, with respect to a total sum of the first alloy powder and the second alloy powder, a content of the second alloy powder is 20 to 50 vol % in terms of volume ratio, to prepare a magnetic powder.

In the method of the present disclosure, it is also preferred that the step of preparing the first alloy powder includes a heat treatment step of heat treating the amorphous powder prepared in the first spraying step to prepare a crystalline powder having an average crystallite diameter of 50 nm or less, the crystalline powder is used as the first alloy powder in place of the amorphous powder, and the first alloy powder and the second alloy powder are mixed so that, with respect to the total sum of the first alloy powder and the second alloy powder, the content of the second alloy powder is 20 to 50 vol % in terms of volume ratio, to prepare a magnetic powder. In this case, since the first alloy powder includes the crystalline phase having the average crystallite size of 50 nm or less, it is possible to reduce the coercive force and to obtain a magnetic powder with lower magnetic loss. Furthermore, in the method of the present disclosure, it is preferred that the average crystallite size of the first alloy powder differs depending on the heat treatment temperature during the heat treatment.

In the first spraying step, it is preferred to spray a mixed gas formed by adding hydrogen gas to an inert gas on the molten metal. Thereby, mixing of oxygen into the magnetic powder can be more effectively avoided, and therefore mixing of impurities resulting from oxygen can be avoided as much as possible.

Furthermore, in the method of the present disclosure, the inert gas is preferably one of an argon gas and a nitrogen gas which is relatively inexpensive and easily available. Further, a magnetic core according to the present disclosure is characterized in that a main component is formed of a composite material of the magnetic powder described above and a resin powder.

Furthermore, in the magnetic core of the present disclosure, it is preferable that a content of the magnetic powder in the composite material is 60 to 90 vol % in terms of volume ratio. Thereby, it is possible to obtain a magnetic core having good corrosion resistance and desired good magnetic characteristics without damaging the binding property between the magnetic powders.

A method for producing a magnetic core according to the present disclosure includes a forming step of mixing a magnetic powder prepared by the production method described above with a resin powder and subjecting a resulting mixture to forming treatment to prepare a compact, and a heat treatment step of heat treating the compact.

Further, a coil component according to the present disclosure is a coil component including a coil conductor wound around a core part, in which the core part is formed of the above-mentioned magnetic core. Furthermore, a coil component according to the present disclosure is a coil component including a coil conductor buried in a magnetic part, in which a main component of the magnetic part is predominantly composed of a composite material containing the magnetic powder described above and a resin powder.

In the coil component of the present disclosure, it is preferable that a content of the magnetic powder in the composite material of the magnetic part is 60 to 90 vol % in terms of volume ratio. Also in this case, as with the magnetic core described above, it is possible to obtain a coil component having good corrosion resistance and desired good magnetic characteristics without damaging the binding property between the magnetic powders.

According to the present disclosure, since the magnetic powder contains a plurality of kinds of alloy powders including at least a first alloy powder and a second alloy powder in which those composition are different, in which the second alloy powder has a median diameter smaller than a median diameter of the first alloy powder and contains Cr in a range of 0.3 to 14 at %; a content of Cr of the first alloy powder is 0.3 at % or less; with respect to a total sum of the first alloy powder and the second alloy powder, a content of the second alloy powder is 20 to 50 vol %; a ratio of the median diameter of the first alloy powder to the median diameter of the second alloy powder is 4 to 20; and the first alloy powder includes at least any one of an amorphous phase and a crystalline phase having an average crystallite size of 50 nm or less, the first alloy powder having the large median diameter has less Cr, which is a nonmagnetic metal element, and thus, it is possible to obtain a high saturation magnetic flux density. In addition, the second alloy powder having the small median diameter contains Cr moderately, and thereby surface corrosion hardly occurs and corrosion resistance can be ensured. An oxide film of Cr is formed on the surface of the second alloy powder having the small median diameter and the large surface area, and thereby it is possible to increase the insulation resistance, and as a result, it is possible to obtain a magnetic powder with low magnetic loss.

In addition, the coercive force becomes small by causing the first alloy powder to have the crystalline phase having the average crystallite size of 50 nm or less, so that even when the first alloy powder is formed to have a crystalline phase, it is possible to obtain a magnetic powder having good characteristics with low magnetic loss. As described above, it is possible to obtain a magnetic powder having good insulation resistance and saturation magnetic flux density, low magnetic loss and good corrosion resistance.

According to a method for producing a magnetic powder of the present disclosure, since the method containing at least a first alloy powder and a second alloy powder in which those composition and median diameter are different, a step of preparing the first alloy powder includes a first mixing step of weighing and mixing predetermined base materials, a first heating step of heating the mixed product to prepare a molten metal, and a first spraying step of spraying an inert gas on the molten metal to pulverize the molten metal and to prepare an amorphous powder. A step of preparing the second alloy powder includes a second mixing step of weighing and mixing predetermined base materials containing Cr so as to contain the Cr in a range of 0.3 to 14 at %, a second heating step of heating the mixed product to prepare a molten metal, and a second spraying step of spraying water on the molten metal to pulverize the molten metal and to obtain a second alloy powder in which a median diameter ratio between a median diameter of a first alloy powder and a median diameter of a second alloy powder is 4 to 20. The amorphous powder is used as the first alloy powder, and the first alloy powder and the second alloy powder are mixed so that, with respect to a total sum of the first alloy powder and the second alloy powder, a content of the second alloy powder is 20 to 50 vol %, to prepare a magnetic powder. In the step of preparing the first alloy powder, it is possible to obtain a spherical first alloy powder of high quality by a gas atomization method, and in the step of preparing the second alloy powder, it is possible to obtain the second alloy powder that has the small median diameter due to a water atomization method and that can ensure good corrosion resistance and high insulation resistance since an appropriate amount of Cr is added. Thereby, it is possible to produce, with high efficiency, a desired magnetic powder having good insulation resistance and high saturation magnetic flux density, low magnetic loss and high corrosion resistance.

According to the magnetic core of the present disclosure, since a main component is formed of the composite material of the magnetic powder described above and a resin powder, it is possible to obtain, with high efficiency, a magnetic core that has good corrosion resistance and low magnetic loss without damaging insulation resistance and saturation magnetic flux density.

According to the method for producing a magnetic core of the present disclosure, since the method includes a forming step of mixing the magnetic powder prepared by the production method described above with a binder and subjecting the resulting mixture to forming treatment to prepare a compact, and a heat treatment step of heat treating the compact, a desired magnetic core having good corrosion resistance and good magnetic characteristics can be easily prepared.

Further, according to a coil component of the present disclosure, since the coil component includes a coil conductor wound around a core part, and the core part is formed of the magnetic core described above, it is possible to easily obtain a coil component, such as a reactor, which has good corrosion resistance and low magnetic loss without damaging insulation resistance and saturation magnetic flux density. Furthermore, according to the coil component of the present disclosure, since the coil component includes a coil conductor buried in a magnetic part, and a main component of the magnetic part contains the magnetic powder described above and a resin powder, it is possible to obtain, with high efficiency, a coil component, such as an inductor, which has good corrosion resistance and low magnetic loss without damaging insulation resistance and saturation magnetic flux density.

The above and other objects, features, and advantages of the disclosure will become more apparent from the following description.

### BRIEF DESCRIPTION OF DRAWINGS

FIG. 1 is a view showing an example of a magnetic hysteresis curve;

FIG. 2A is a view showing an essential part diffraction profile of a crystal phase of a magnetic powder;

FIG. 2B is a view showing an essential part diffraction profile of an amorphous phase;

FIG. 3 is a sectional view showing an example of an atomization device;

FIG. 4 is a perspective view showing an embodiment of a magnetic core according to the present disclosure;

FIG. 5 is a perspective view showing an internal structure of a reactor as a first embodiment of a coil component according to the present disclosure;

FIG. 6 is a perspective view of an inductor as a second embodiment of a coil component according to the present disclosure;

FIG. 7 is a perspective view showing an internal structure of the inductor; and

FIG. 8 is a SEM image of sample No. 6.

### DETAILED DESCRIPTION

Next, embodiments of the present disclosure will be described in detail.

The magnetic powder according to the present disclosure contains a plurality of kinds of alloy powders including at least a first alloy powder having a median diameter D₅₀ and a second alloy powder having a median diameter D₅₀′ in which those composition are different.

The median diameter D₅₀′ of the second alloy powder is smaller than the median diameter D₅₀ of the first alloy powder, and the second alloy powder contains Cr in the range of 0.3 to 14 at % in terms of atomic ratio. In addition, the content of Cr in the first alloy powder is 0.3 at % or less in terms of atomic ratio.

Further, with respect to the total sum of the first alloy powder and the second alloy powder, a content of the second alloy powder is set to 20 to 50 vol % in terms of volume ratio, and the ratio of the median diameter D₅₀ of the first alloy powder to the median diameter D₅₀′ of the second alloy powder (median diameter ratio D₅₀/D₅₀′) is set to 4 to 20. That is, the first alloy powder having the large median diameter D₅₀ contributes to improvement of magnetic characteristics such as improvement in saturation magnetic flux density and reduction in magnetic loss. When the second alloy powder having the median diameter D₅₀′ smaller than the median diameter D₅₀ of the first alloy powder is mixed with the first alloy powder, the voids formed between the first alloy powders are filled with the second alloy powder, so that the filling property can be improved, and thus, the magnetic coupling among the particles can be facilitated to further improve the magnetic characteristics. However, in the production process or the like, the surface of the particle is in contact with impurities such as oxygen, and therefore, there is a possibility that corrosion of the particle surface proceeds, resulting in the deterioration of magnetic characteristics such as the saturation magnetic flux density.

Thereupon, in the present embodiment, for the first alloy powder that greatly contributes to the magnetic characteristics, the content of Cr as nonmagnetic element having corrosion resistance is suppressed as much as possible, and on the other hand, for the second alloy powder that has the small median diameter D₅₀′ and relatively small contribution to the magnetic characteristics, a predetermined amount of Cr is contained, and the mixing ratio and median diameter ratio D₅₀/D₅₀′ of the first and second alloy powders are controlled so as to fall within the above-mentioned predetermined ranges. Thereby, a magnetic powder having high insulation resistance and high saturation magnetic flux density, low magnetic loss and good corrosion resistance is obtained.

Next, the reasons why the Cr contents of the first and second alloy powders, mixing ratio, and median diameter ratio D₅₀/D₅₀′ are set to the above-mentioned ranges will be described in detail.

(1) Cr Content of the Second Alloy Powder

The second alloy powder having the small median diameter D₅₀′ and the large specific surface area has a relatively small contribution to magnetic characteristics. Therefore, when Cr that is nonmagnetic but has good corrosion resistance is contained in the second alloy powder, the corrosion resistance can be improved. For that purpose, it is necessary that the Cr content in the second alloy powder is at least 0.3 at % in terms of atomic ratio. On the other hand, when the Cr content in the second alloy powder exceeds 14 at % in terms of atomic ratio, the magnetic characteristics are affected, resulting in the reduction of the saturation magnetic flux density.

Thus, in the present embodiment, the Cr content in the second alloy powder is set to 0.3 to 14 at %. In addition, the Cr content in the second alloy powder is preferably 1.0 to 14 at % in order to further improve the corrosion resistance without lowering the saturation magnetic flux density.

(2) Cr Content of the First Alloy Powder

The first alloy powder having the large median diameter D₅₀ greatly contributes to magnetic characteristics such as magnetic flux saturation density and magnetic loss, and thus it is thought that the content of Cr as a nonmagnetic element is preferably as small as possible, and more preferably no Cr is contained, but there is a possibility that Cr is inevitably mixed in the process of producing the magnetic powder.

However, when the content of Cr in the first alloy powder exceeds 0.3 at % in terms of atomic ratio, Cr as a nonmagnetic metal is excessively contained, and it is difficult to ensure a desired saturation magnetic flux density. Thus, in the present embodiment, the Cr content in the first alloy powder is kept below 0.3 at %.

(3) Mixing Ratio of the First Alloy Powder and the Second Alloy Powder

As described above, the first alloy powder having the large median diameter D₅₀ contributes to improvement of magnetic characteristics such as improvement in saturation magnetic flux density and reduction in magnetic loss. On the other hand, the second alloy powder having the small median diameter D₅₀′ contributes to improvement of the filling property of the magnetic powder. Therefore, by mixing the first alloy powder and the second alloy powder, it is possible to facilitate the magnetic coupling between the particles to further improve the magnetic characteristics. However, when, with respect to the total sum of the first alloy powder and the second alloy powder, the content of the second alloy powder is less than 20 vol % in terms of volume ratio, the first alloy powder having the large median diameter D₅₀ is excessive, the filling property is lowered, the magnetic coupling between the particles is lowered, and thereby there is a possibility that the magnetic characteristics such as a saturation magnetic flux density are deteriorated.

On the other hand, when the content of the second alloy powder exceeds 50 vol % in terms of volume ratio, the volume content of the second alloy powder is excessive, and the volume content of the first alloy powder that greatly contributes to the improvement of the magnetic characteristics is lowered. Consequently, there is a possibility that the saturation magnetic flux density is lowered, resulting in the deterioration of the magnetic characteristics. Therefore, in the present embodiment, the content of the second alloy powder is set to 20 to 50 vol % with respect to the total sum of the first alloy powder and the second alloy powder.

(4) Median Diameter Ratio D₅₀/D₅₀′

Since desired characteristics can be obtained by mixing the first alloy powder and the second alloy powder, there is also an appropriate range for the median diameter ratio D₅₀/D₅₀′ of both powders. That is, when the median diameter ratio D₅₀/D₅₀′ is less than 4, the difference between the median diameter D₅₀ of the first alloy powder and the median diameter D₅₀′ of the second alloy powder is small, and adequate improvement of the filling property due to the second alloy powder cannot be achieved. Accordingly, it is not possible to obtain a sufficient saturation magnetic flux density, and deterioration of the magnetic characteristics may be caused.

On the other hand, when the median diameter ratio D₅₀/D₅₀′ exceeds 20, the difference between the median diameter D₅₀ of the first alloy powder and the median diameter D₅₀′ of the second alloy powder is large, and also in this case, adequate improvement of the filling property due to the second alloy powder cannot be achieved. Accordingly, it is not possible to obtain a sufficient saturation magnetic flux density, and deterioration of the magnetic characteristics may be caused. Therefore, in the present embodiment, the median diameter ratio D₅₀/D₅₀′ is set to 4 to 20.

As the powder structure phase of the first alloy powder that greatly contributes to the improvement of the magnetic characteristics, an amorphous phase having good soft magnetic characteristics is preferred; however, in this embodiment, when an average crystallite size is 50 nm or less, the first alloy powder may have a crystalline phase, and thereby, a desired low magnetic loss can be realized.

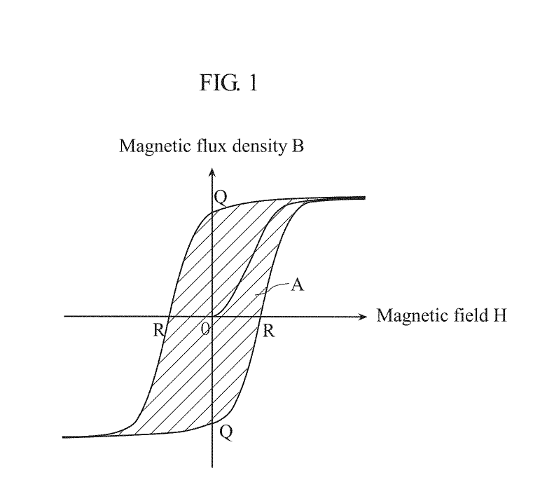

FIG. 1 is a magnetic hysteresis curve showing the relationship between a magnetic field H and a magnetic flux density B. In the figure, the horizontal axis (x axis) represents the magnetic field H, the vertical axis (y axis) represents the magnetic flux density B, the x intercept represents a coercive force R and the y intercept represents a residual magnetic flux density Q.

Since the hysteresis area indicated by the hatched portion A corresponds to the magnetic loss, the smaller the absolute value of the coercive force R is, the smaller the magnetic loss becomes. On the other hand, it is known that the coercive force R decreases as crystallite size that can be regarded as single crystals, that is, an average crystallite size D becomes small. Accordingly, by controlling the average crystallite size D so that the coercive force R becomes sufficiently small, the magnetic loss can be effectively suppressed.

Thereupon, the present inventor has made studies, and consequently found that by setting the average crystallite size D to 50 nm or less, it is possible to obtain a desired low magnetic loss without affecting the corrosion resistance, the insulation resistance and the saturation magnetic flux density. That is, when the first alloy powder has the average crystallite size of 50 nm or less, it is possible to use the first alloy powder having a crystalline phase, so that a low magnetic loss magnetic powder can be realized without affecting other characteristics. In addition, the second alloy powder may have either a crystalline phase or an amorphous phase. Herein, the powder structure phase of each of the first and second alloy powders can be easily identified by measuring the X-ray diffraction spectrum with an X-ray diffraction method.

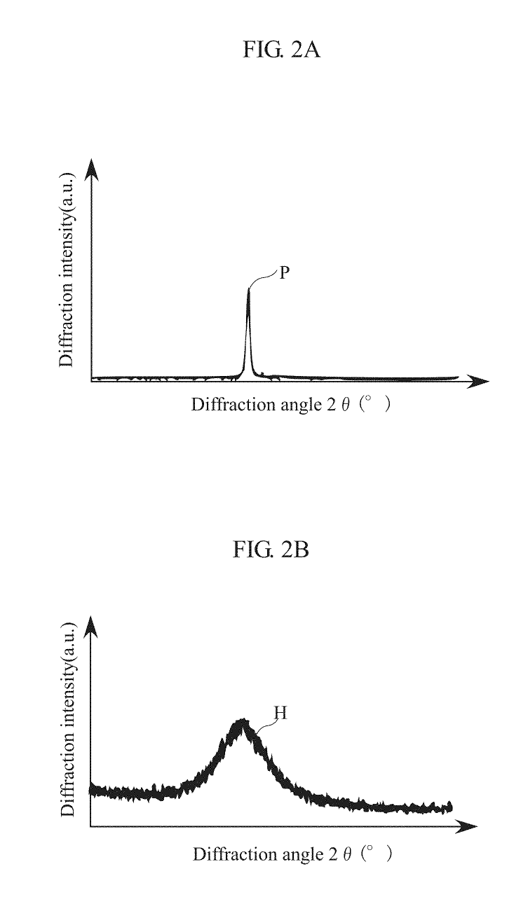

FIGS. 2A and 2B show an essential part of an X-ray diffraction spectrum of the magnetic powder. The horizontal axis represents a diffraction angle 2θ (°) and the vertical axis represents diffraction intensity (a. u.).

For example, when the first and second alloy powders each have a crystalline phase, a portion indicating the crystalline phase has a diffraction peak P in the vicinity of a predetermined angle of the diffraction angle 2θ, as shown in FIG. 2A. On the other hand, when the first and second alloy powders each have an amorphous phases, a halo H indicating the amorphous phase is formed in the vicinity of a predetermined angle of the diffraction angle 2θ, as shown in FIG. 2B.

In this manner, the powder structure phase of each of the first and second alloy powders can be easily identified by applying the X-ray diffraction method. Further, as is clear from the examples described later, the average crystallite size of the first alloy powder can also be determined from the measurement results by the X-ray diffraction method.

Although the material system of the first alloy powder is not particularly limited, a material containing a Fe—Si—B—P-based material as a main component is preferred, and it is also preferred to contain Ni, Co, Cu, C or the like in a predetermined amount as required. For example, as the first alloy powder, it is also preferred to use a material which contains the Fe—Si—B—P-based material as the main component and in which a part of Fe in the Fe—Si—B—P-based material is substituted with any element of Ni and Co in the range of 12 at % or less, or in which a part of Fe in the Fe—Si—B—P-based material is substituted with Cu in the range of 1.5 at % or less, and it is also preferred to use a material in which a part of B in the Fe—Si—B—P-based material is substituted with C in the range of 4 at % or less. Even when predetermined amount(s) of Ni, Co, Cu, and/or C are/is contained in the Fe—Si—B—P-based material as described above, a magnetic powder having good corrosion resistance, insulation resistance and magnetic characteristics, and having low magnetic loss can be obtained.

Also, the kind of material of the second alloy powders is not limited, as long as the material contains a predetermined amount of Cr. In addition, since the second alloy powder less contributes to the magnetic characteristics than the first alloy powder, a wider range of kinds of material can be selected. For example, it is possible to use crystalline materials containing a Fe—Si—Cr as a main component, amorphous materials containing a Fe—Si—B—P—Cr, a Fe—Si—B—P—C—Cr, a Fe—Si—B—Cr or a Fe—Si—B—C—Cr as a main component, or materials obtained by substituting a part of Fe of these crystalline materials or amorphous materials with Ni and/or Co.

The Fe—Si—Cr based material has good toughness as compared with a Fe—Al—Si-based material, so that it is excellent in processability. Further, the Fe—Si—Cr-based material contains a predetermined amount of Cr, so that it can ensure corrosion resistance. Accordingly, it is possible to yield a magnetic powder having good insulation resistance and magnetic characteristics in combination with the action of the first alloy powder.

Although the median diameters D₅₀ and D₅₀′ of each of the first and second alloy powders are not particularly limited as long as the median diameter ratio D₅₀/D₅₀′ satisfies 4 to 20, the median diameter D₅₀ of the first alloy powder is preferably 20 to 55 μm, and the median diameter D₅₀′ of the second alloy powder is preferably 1.5 to 5.5 μm. In particular, if the median diameter D₅₀ of the first alloy powder is excessively small, not only the median diameter ratio D₅₀/D₅₀′ satisfies 4 to 20 with difficulty, but also corrosion resistance is deteriorated.

Although the above-mentioned method for producing a magnetic powder is not particularly limited, it is preferred that the first alloy powder is produced by the gas atomization method, and the second alloy powder is produced by the water atomization method.

The gas atomization method is not suitable for high pressure spraying applications such as water atomization method since its jet fluid is mainly composed of an inert gas, but the gas atomization method is low in absorption of oxygen and can suppress mixing of impurities. Accordingly, this method is suitable for obtaining a high quality first alloy powder having a large median diameter D₅₀ and being spherical and easy to handle.

On the other hand, in the water atomization method, since water is used as a jet fluid, high pressure spraying is possible. This method is suitable for obtaining a second alloy powder having a median diameter D₅₀′ as compared to the gas atomization method, although the powder shape is not uniform. As compared to the gas atomization method, impurities such as oxygen are easily mixed, but in the present embodiment, the second alloy powder contains Cr having excellent corrosion resistance, so that surface corrosion can be suppressed. When the first alloy powder is constituted of a crystalline phase having the average crystallite size of 50 nm or less, such a powder can be obtained by synthesizing the first alloy powder consisting of an amorphous phase as described above and then being subjected to a heat treatment at a temperature of about 400 to 475° C.

Hereinafter, the method for producing a magnetic powder of the present disclosure will be described in detail.

{Preparation of First Alloy Powder}

As base materials, elements or a compound containing these elements that constitute a first alloy powder, such as Fe, Si, B and Fe₃P, are prepared, and predetermined amounts of them are weighed and mixed to obtain an alloy material. Next, a first alloy powder is prepared using a gas atomization method.

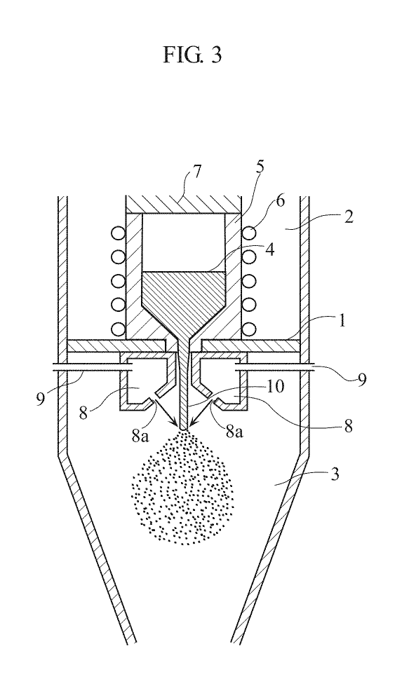

FIG. 3 is a sectional view showing an embodiment of a gas atomization device. The gas atomization device is divided into a melting chamber 2 and a spraying chamber 3 with a divider 1 interposed between the melting chamber 2 and the spraying chamber 3.

The melting chamber 2 includes a crucible 5 formed of alumina or the like in which a molten metal 4 is held, an induction heating coil 6 arranged at a perimeter of the crucible 5, and a top panel 7 for closing the crucible 5. The spraying chamber 3 includes a gas injection chamber 8 provided with an injection nozzle 8a, a gas supply tube 9 that supplies an inert gas as a jet fluid to the gas injection chamber 8, and a molten metal supply tube 10 that guides the molten metal 4 to the spraying chamber 3.

In the gas atomization device configured as described above, first, a high-frequency power source is applied to the induction heating coil 6 to heat the crucible 5, and an alloy material is supplied to the crucible 5 to melt the alloy material, and thus, the molten metal 4 is prepared. Then, an inert gas as a jet fluid is supplied to the gas supply tube 9 and the gas injection chamber 8, and the inert gas is sprayed from the injection nozzle 8a to the molten metal 4 falling from the molten metal supply tube 10, as indicated by an arrow, to pulverize/quench the molten metal 4, and therefore, an amorphous powder is prepared and the amorphous powder is used as a first alloy powder.

In the above-mentioned production method, the inert gas is used as a jet fluid in the spraying process, and further it is also preferred to use a mixed gas formed by adding hydrogen gas of 0.5 to 7% in terms of partial pressure to an inert gas. Further, the inert gas is not particularly limited, and helium gas, neon gas, or the like can also be used, but argon gas or nitrogen gas that is easily available and inexpensive is usually used preferably.

When the powder structure phase of the first alloy powder is formed of a crystalline phase having the average crystallite size of 50 nm or less, the amorphous powder is subjected to heat treatment at a predetermined temperature for about 0.1 to 10 minutes. Then, the powder structure phase undergoes a phase change from an amorphous phase to a crystalline phase, so that a crystalline powder having the average crystallite size of 50 nm or less is prepared, and this becomes the first alloy powder. Although the heat treatment temperature is not particularly limited, the average crystallite size varies depending on the heat treatment temperature, and therefore, the heat treatment temperature is set to an appropriate temperature so that the average crystallite size is 50 nm or less, and the heat treatment temperature is set to, for example, about 400 to 475° C.

{Preparation of Second Alloy Powder}

As base materials, elements or compounds containing these elements that constitute a second alloy powder, such as Fe, Si, and Cr, were prepared, and predetermined amounts of them were weighed and mixed to obtain an alloy material. Next, a second alloy powder is prepared using a water atomization method. A water atomization device is the same as the gas atomization device except that the inert gas is changed to water as the jet fluid.

That is, first, a molten metal is prepared by the same procedure and method as the method for preparing the first alloy powder. Then, water as a jet fluid is supplied to a water supply tube and a water injection chamber, and water is sprayed from the injection nozzle under high pressure to the molten metal falling from the molten metal supply tube to pulverize/quench the molten metal, and thus, an amorphous or crystalline second alloy powder having a median diameter D₅₀′, in which the median diameter ratio D₅₀/D₅₀′ satisfies 4 to 20, is prepared.

{Preparation of Magnetic Powder}

For the first and second alloy powders in which the median diameter ratio D₅₀/D₅₀′ is 4 to 20, the first alloy powder and the second alloy powder are mixed so that the volume content of the second alloy powder to the total sum of the first and second alloy powders is 20 to 50 vol %, and thus a magnetic powder is prepared.

As described above, according to the method for producing a magnetic powder of the present disclosure, in the step of preparing the first alloy powder, the spherical first alloy powder of high quality consisting of amorphous phase can be obtained by the gas atomization method, and the first alloy powder consisting of the crystalline phase having the average crystallite size of 50 nm or less can be obtained by subsequent suitable heat treatment. Furthermore, in the step of preparing the second alloy powder, the second alloy powder has the small median diameter due to the water atomization method and the predetermined amount of Cr is added to the second alloy powder, so that the second alloy powder can be obtained in which corrosion resistance is good and a desired insulation property is ensured. Accordingly, it is possible to produce, with high efficiency, a desired magnetic powder having low magnetic loss and good corrosion resistance without impairing insulation resistance and saturation magnetic flux density.

Next, a magnetic core using the magnetic powder will be described.

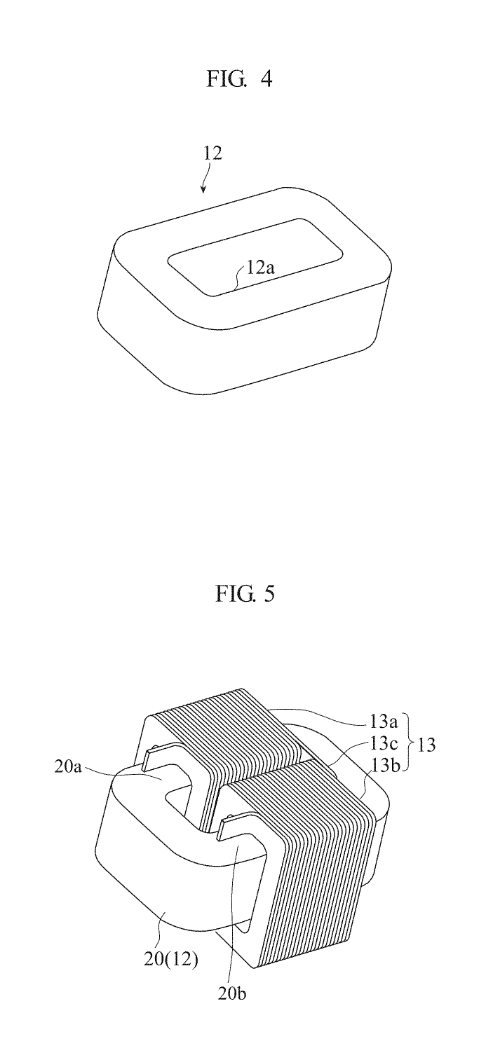

FIG. 4 is a perspective view showing an embodiment of a magnetic core according to the present disclosure, and a magnetic core 12 is formed into a ring shape having a long hole-shaped hole part 12a. The magnetic core 12 can be easily produced in the following manner.

That is, the present magnetic powder described above and a resin material (binder) such as an epoxy resin are kneaded and dispersed to prepare a composite material. Then, the composite material is subjected to forming treatment using, for example, a compression forming method or the like to prepare a compact. That is, the composite material is poured into a cavity of a heated mold, pressurized to about 100 MPa, and pressed to prepare a compact. Thereafter, the compact is taken out from the mold, and subjected to heat treatment at a temperature of 120 to 150° C. for about 24 hours to accelerate curing of the resin material, so that the aforementioned magnetic core 12 is prepared.

The content of the magnetic powder in the composite material is not particularly limited, and is preferably from 60 to 90 vol % in terms of volume ratio. When the content of the magnetic powder is less than 60 vol %, the content of the magnetic powder is excessively low, and there is a possibility that the magnetic permeability or the saturation magnetic flux density is lowered to cause the deterioration of magnetic characteristics. On the other hand, when the content of the magnetic powder exceeds 90 vol %, the content of the resin material decreases and there is a possibility that the magnetic powders cannot be sufficiently bound to each other.

FIG. 5 is a perspective view showing a reactor as a first embodiment of a coil component according to the present disclosure.

In the reactor, a coil conductor 13 is wound around a core part 20, and the core part 20 is formed of the magnetic core 12. That is, the long hole-shape core part 20 has two long side parts 20a and 20b parallel to each other. The coil conductor 13 consists of a first coil conductor 13a wound around one long side part 20a, a second coil conductor 13b wound around the other long side part 20b, and a connecting part 13c which connects the first coil conductor 13a and the second coil conductor 13b, and these first coil conductor 13a, second coil conductor 13b, and connecting part 13c are unified. Specifically, in the coil conductor 13, one rectangular wire lead made of copper or the like is coated with an insulating resin such as a polyester resin or a polyamide imide resin, and wound around both of the one long side part 20a and the other long side part 20b of the core part 20 in the form of a coil. Thus, in the present reactor, since the coil conductor 13 is wound around the core part 20 composed of the magnetic core 12, it is possible to obtain the reactor that has good corrosion resistance and low magnetic loss without damaging insulation resistance and saturation magnetic flux density with high efficiency.

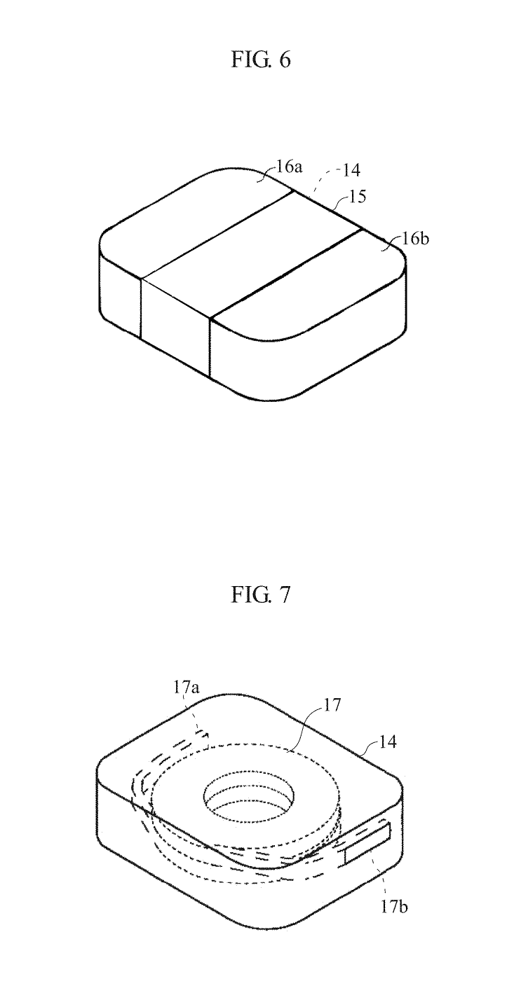

FIG. 6 is a perspective view of an inductor as a second embodiment of a coil component according to the present disclosure. In the inductor, a protection layer 15 is formed on a central part of a surface of a magnetic part 14 formed into a rectangular shape, and a pair of external electrodes 16a and 16b are formed in a state of sandwiching the protection layer 15 at both ends of the surface of the magnetic part 14.

FIG. 7 is a view showing an internal structure of the inductor. In FIG. 7, the protection layer 15 and the external electrodes 16a and 16b in FIG. 6 are omitted for convenience of explanation.

The magnetic part 14 contains the magnetic powder of the present disclosure as a main component, and is formed of a composite material containing a resin material such as an epoxy resin. A coil conductor 17 is buried in the magnetic part 14.

The coil conductor 17 has a cylindrical shape formed by winding a rectangular wire in the form of a coil, and both ends 17a and 17b are exposed to the end surface of the magnetic part 14 so that the both ends 17a and 17b can be electrically connected to the external electrodes 16a and 16b. Specifically, in the coil conductor 17, as with the first embodiment, a rectangular wire lead made of copper or the like is coated with an insulating resin such as a polyester resin or a polyamide imide resin and formed into a belt shape, and wound in the form of a coil so as to have a hollow core.

The inductor can be easily prepared in the following manner.

First, the present magnetic powder and a resin material are kneaded and dispersed to prepare a composite material as with the first embodiment. Then, the coil conductor 17 is buried in the composite material so that the coil conductor 17 is sealed with the composite material. A forming process is applied using, for example, a compression forming method or the like to obtain the compact in which the coil conductor 17 is buried. Then, the compact is taken out of a forming die, heat treated, and subjected to surface polishing to obtain the magnetic part 14 in which the ends 17a and 17b of the coil conductor 17 are exposed to end surfaces.

Next, an insulating resin is applied to the surface of the magnetic part 14 other than an area where the external electrodes 16a and 16b are formed and the resin is cured to form the protection layer 15. Thereafter, the external electrodes 16a and 16b containing a conductive material as the principal component are formed at both ends of the magnetic part 14, and thereby, the inductor is prepared.

The method for forming the external electrodes 16a and 16b is not particularly limited, and these electrodes can be formed by an optional method, such as an application method, a plating method, or a thin film forming method.

As described above, in the present inductor, the coil conductor 17 is buried in the magnetic part 14 and the magnetic part 14 contains the above-described magnetic powder as a main component, so that it is possible to obtain, with high efficiency, a coil component that has good corrosion resistance and low magnetic loss without damaging insulation resistance and saturation magnetic flux density.

The present disclosure is not limited to the above-mentioned embodiments, and various variations may be made without departing from the gist of the disclosure. In the above embodiments, although the magnetic powder is formed of a mixture of two kinds of the first alloy powder and the second alloy powder, the magnetic powder may only to satisfy the above-mentioned range in the relationship between the first alloy powder and the second alloy powder, and the magnetic powder may further contain a slight amount of an alloy powder.

In addition, the powder structure phase of the first alloy powder may only to include at least any one of the amorphous phase and the crystalline phase having the average crystallite size of 50 nm or less. Therefore, the powder structure phase may include both phases.

In the above embodiment, a reactor or an inductor is exemplified as a coil component, and furthermore the present disclosure may be applied to a stator core to be mounted on a motor or the like. Further, the production method of the magnetic core 12 or the magnetic part 14 is not limited to the compression forming method described above and an injection molding method or a transfer molding method may be used.

In the above embodiment, the mixed product is heated/melted by high frequency induction heating; however, a heating/melting method is not limited to the high frequency induction heating, and for example, arc melting may be employed.

Next, examples of the present disclosure will be specifically described.

### EXAMPLES

### Example 1

{Preparation of First Alloy Powder}

As base materials for the first alloy powder, Fe, Si, B, Fe₃P, and Cr were prepared. Then, these base materials were weighed and mixed so that the composition formula was Fe₇₆Si₉B₁₀P₅, or (Fe₇₆Si₉B₁₀P₅)ₓCr_{y} (x=90 to 99.8, y=0.2 to 10). The resulting mixtures were each heated to a melting point or higher in a high frequency induction furnace to be melted, and then the melted products were poured into a casting mold made of copper and cooled, and thereby master alloys were prepared.

Next, a gas atomization device was prepared which had an atmosphere of a mixed gas formed by adding hydrogen gas of 3% in terms of partial pressure to argon gas. Then, each of the master alloys was pulverized into a size of about 5 mm, charged into a crucible of the gas atomization device, and melted by high frequency induction heating to obtain a molten metal. Subsequently, the argon gas adding the hydrogen gas as a jet fluid was sprayed to the molten metal to pulverize/quench the molten metal, and the resulting product was classified by sieve to obtain various first alloy powders in which those component composition were different.

The median diameter D₅₀ of each of these first alloy powders was measured with a particle diameter distribution analyzer (LA-300, manufactured by HORIBA, Ltd.), and consequently the median diameter was 14 to 53 μm. Using a powder X-ray diffractometer (RINT 2200, manufactured by Rigaku Corporation), an X-ray diffraction spectrum was measured with use of CuKα (wavelength λ: 0.1540538 nm) as the characteristic X-ray in measuring conditions of step width of 0.02° and step time of 2 seconds in a range in which a diffraction angle 2θ ranges from 30° to 90°, and a powder structure phase of each sample was identified from the X-ray diffraction spectrum. As a result, no peak indicating a crystalline phase was detected in any of the first alloy powders, and a halo indicating an amorphous phase was detected, and therefore each sample was identified as an amorphous phase.

{Preparation of Second Alloy Powder}

As base materials for a second alloy powder, Fe, Si, B, Fe₃P, Cr, C, and Ni were prepared. Then, these base materials were weighed and mixed so that the composition formula was Fe₈₈Si₁₂, Fe_{α}Si₉B₁₀P₅Cr_{β} (α=75 to 75.9, β=0.1 to 1), Fe_{γ}Si_{δ}Cr_{η} (γ=81 to 84, δ=10 or 11, η=5 to 14), Fe₇₇Si₁₁B₁₀C₁Cr₁, or Fe₇₄Ni₃Si₁₁B₁₀C₁Cr₁. Then, as with the above-mentioned procedure for preparing the first alloy powder, the resulting mixtures were each heated to a melting point or higher in a high frequency induction furnace to be melted, and then the melted products were poured into a casting mold made of copper and cooled, and thereby master alloys were prepared.

Next, a water atomization device was prepared in which the periphery of a crucible had an atmosphere of a mixed gas formed by adding hydrogen gas of 3% in terms of partial pressure to argon gas. Then, the master alloy was pulverized into a size of about 5 mm, charged into the crucible of the water atomization device, and melted by high frequency induction heating to obtain a molten metal. Subsequently, high-pressure water of 10 to 80 MPa was sprayed on the molten metal to pulverize/quench the molten metal, so that various second alloy powders that were different in component composition were obtained.

The median diameter D₅₀′ and X-ray diffraction spectrum of each of these second alloy powders were measured in the same manner as described above. As a result, it was verified that the median diameter D₅₀′ was 1.7 to 22 μm, and in the powder structure phase, either a crystal phase or an amorphous phase was formed depending on the component composition.

{Preparation of Sample}

The first and second alloy powders were weighed and mixed so that the volume content of the second alloy powder was the volume ratio as shown in Table 2. To 100 parts by weight of the resulting mixture was added 3 parts by weight of an epoxy resin (the proportion of the epoxy resin was 15 vol %), and the resulting mixture was press-molded at a temperature of 160° C. for 20 minutes at a pressure of 100 MPa to obtain disk-shaped samples of Nos. 1 to 28 each having an outer diameter of 8 mm and a thickness of 5 mm, and toroidal cores each having an outer diameter of 13 mm, an inner diameter of 8 mm and a thickness of 2.5 mm.

{Evaluation of Sample}

(Corrosion Resistance)

Each of the disk-shaped samples of Nos. 1 to 28 was allowed to stand for 100 hours under the conditions of an ambient temperature of 60° C. and a relative humidity of 95% RH, and when the surface color of the sample was gray color similar to the color of the sample before the test, the sample was judged as excellent (◯) in corrosion resistance, and when the surface color changed from gray color before the test to ocher color or brown color was judged as defective (×).

(Specific Resistance)

With respect to each of the disk-shaped samples of Nos. 1 to 28, the specific resistance was measured using an insulation resistance meter (manufactured by HIOKI E.E. CORPORATION, SUPER MEGOHMMETER SM8213), and a sample having a specific resistance of 1.0×10⁸ Ω·m or more was judged as good product.

(Measurement of Saturation Magnetic Flux Density)

10 mg of each of the mixtures before molding into sample Nos. 1 to 28 was taken, the sample was placed on a non-magnetic adhesive tape, and the adhesive tape was doubled up to be formed into a plate of 7 mm long and 7 mm wide. Next, saturation magnetization at room temperature (25° C.) was measured at a maximum applied magnetic field of 12,000 A/m using Vibrating Sample Magnetometer (VSM-5-10 manufactured by Toei Industry Co., Ltd.). Then, a saturation magnetic flux density was calculated from the measured value and the true specific gravity of the sample, and a sample having a saturation magnetic flux density of 1.15 T or more was judged as a good product.

(Core Loss)

With respect to each of the toroidal cores of sample Nos. 1 to 28, an enameled copper wire having a wire diameter of 0.3 mm was doubly wound around the periphery of a toroidal core so that the number of turns of primary windings for excitation and the number of turns of secondary windings for voltage detection were each 16, to obtain a sample for measuring the core loss. Then, using a B-H analyzer (SY-8217 manufactured by IWATSU ELECTRIC CO., LTD.), a core loss (magnetic loss) was measured at a frequency of 1 MHz and at a magnetic field of 40 mT. A sample having a core loss of less than 4,000 kW/m³ was judged as a good product (◯), and a sample having a core loss exceeding 4,000 kW/m³ was judged as a defective product (×).

(Measurement Results)

Tables 1 and 2 show the component composition and measurement results of the respective samples of Nos. 1 to 28.

TABLE 1

| | The first alloy powder | | | The second alloy powder | | |
|---|---|---|---|---|---|---|
| | | Median | | | Median | |
| | | diameter | | | diameter | |
| Sample | | D₅₀ | Identified | | D′₅₀ | Identified |
| No. | Composition | (μm) | phase | Composition | (μm) | phase |
| 1* | Fe₇₆Si₉B₁₀P₅ | 34 | amorphous | Fe₈₈Si₁₂ | 4.4 | crystalline |
| 2* | Fe₇₆Si₉B₁₀P₅ | 34 | amorphous | Fe_{75.9}Si₉B₁₀P₅Cr_{0.1} | 3.9 | amorphous |
| 3 | Fe₇₆Si₉B₁₀P₅ | 34 | amorphous | Fe_{75.7}Si₉B₁₀P₅Cr_{0.3} | 4.0 | amorphous |
| 4 | Fe₇₆Si₉B₁₀P₅ | 34 | amorphous | Fe₇₅Si₉B₁₀P₅Cr₁ | 5.1 | amorphous |
| 5 | Fe₇₆Si₉B₁₀P₅ | 34 | amorphous | Fe₈₄Si₁₁Cr₅ | 4.5 | crystalline |
| 6 | Fe₇₆Si₉B₁₀P₅ | 34 | amorphous | Fe₈₁Si₁₁Cr₈ | 4.9 | crystalline |
| 7 | Fe₇₆Si₉B₁₀P₅ | 34 | amorphous | Fe₇₆Si₁₀Cr₁₄ | 4.1 | crystalline |
| 8 | (Fe₇₆Si₉B₁₀P₅)_{99.8}Cr_{0.2} | 34 | amorphous | Fe₈₄Si₁₁Cr₅ | 4.5 | crystalline |
| 9* | (Fe₇₆Si₉B₁₀P₅)₉₉Cr₁ | 40 | amorphous | Fe₈₄Si₁₁Cr₅ | 4.5 | crystalline |
| 10* | (Fe₇₆Si₉B₁₀P₅)₉₅Cr₅ | 37 | amorphous | Fe₈₄Si₁₁Cr₅ | 4.5 | crystalline |
| 11* | (Fe₇₆Si₉B₁₀P₅)₉₀Cr₁₀ | 34 | amorphous | Fe₈₄Si₁₁Cr₅ | 4.5 | crystalline |
| 12* | Fe₇₆Si₉B₁₀P₅ | 34 | amorphous | — | — | — |
| 13* | Fe₇₆Si₉B₁₀P₅ | 34 | amorphous | Fe₈₁Si₁₁Cr₈ | 4.9 | crystalline |
| 14 | Fe₇₆Si₉B₁₀P₅ | 34 | amorphous | Fe₈₁Si₁₁Cr₈ | 4.9 | crystalline |
| 15 | Fe₇₆Si₉B₁₀P₅ | 34 | amorphous | Fe₈₁Si₁₁Cr₈ | 4.9 | crystalline |
| 16 | Fe₇₆Si₉B₁₀P₅ | 34 | amorphous | Fe₈₁Si₁₁Cr₈ | 4.9 | crystalline |
| 17* | Fe₇₆Si₉B₁₀P₅ | 34 | amorphous | Fe₈₁Si₁₁Cr₈ | 4.9 | crystalline |
| 18* | Fe₇₆Si₉B₁₀P₅ | 34 | amorphous | Fe₈₁Si₁₁Cr₈ | 4.9 | crystalline |
| 19* | Fe₇₆Si₉B₁₀P₅ | 34 | amorphous | Fe₈₁Si₁₁Cr₈ | 4.9 | crystalline |
| 20 | Fe₇₆Si₉B₁₀P₅ | 34 | amorphous | Fe₈₁Si₁₁Cr₈ | 1.7 | crystalline |
| 21 | Fe₇₆Si₉B₁₀P₅ | 34 | amorphous | Fe₈₁Si₁₁Cr₈ | 2.5 | crystalline |
| 22 | Fe₇₆Si₉B₁₀P₅ | 53 | amorphous | Fe₈₁Si₁₁Cr₈ | 4.9 | crystalline |
| 23 | Fe₇₆Si₉B₁₀P₅ | 40 | amorphous | Fe₈₁Si₁₁Cr₈ | 4.9 | crystalline |
| 24 | Fe₇₆Si₉B₁₀P₅ | 22 | amorphous | Fe₈₁Si₁₁Cr₈ | 4.9 | crystalline |
| 25* | Fe₇₆Si₉B₁₀P₅ | 14 | amorphous | Fe₈₁Si₁₁Cr₈ | 4.9 | crystalline |
| 26* | Fe₇₆Si₉B₁₀P₅ | 34 | amorphous | Fe₈₁Si₁₁Cr₈ | 22 | crystalline |
| 27 | Fe₇₆Si₉B₁₀P₅ | 44 | amorphous | Fe₇₇Si₁₁B₁₀C₁Cr₁ | 3.3 | amorphous |
| 28 | Fₑ₇₆Si₉B₁₀P₅ | 44 | amorphous | Fe₇₄Ni₃Si₁₁B₁₀C₁Cr₁ | 3.3 | amorphous |

Mark“*” indicates a sample out of the present disclosure

TABLE 2

| | Volume | | | | | |
|---|---|---|---|---|---|---|
| | content of | | | | Saturation | |
| | the second | Median | | | magnetic | |
| | alloy | diameter | | | flux | |
| Sample | powder | ratio | Corrosion | Resistivity | density | Core |
| No. | (vol %) | (D₅₀/D′₅₀) | resistance | (Ω · m) | (T) | loss |
| 1* | 30 | 7.7 | x | 4.0 × 10⁷ | 1.26 | ∘ |
| 2* | 30 | 8.7 | x | 2.9 × 10⁸ | 1.15 | ∘ |
| 3 | 30 | 8.5 | ∘ | 8.2 × 10⁸ | 1.16 | ∘ |
| 4 | 30 | 6.7 | ∘ | 1.5 × 10⁹ | 1.17 | ∘ |
| 5 | 30 | 7.6 | ∘ | 7.1 × 10⁹ | 1.22 | ∘ |
| 6 | 30 | 6.9 | ∘ | 8.7 × 10⁹ | 1.20 | ∘ |
| 7 | 30 | 8.3 | ∘ | 6.4 × 10⁹ | 1.17 | ∘ |
| 8 | 30 | 7.6 | ∘ | 1.1 × 10¹⁰ | 1.22 | ∘ |
| 9* | 30 | 8.9 | ∘ | 1.0 × 10¹⁰ | 1.14 | ∘ |
| 10* | 30 | 8.2 | ∘ | 1.8 × 10¹⁰ | 1.05 | ∘ |
| 11* | 30 | 7.6 | ∘ | 1.6 × 10¹⁰ | 0.85 | ∘ |
| 12* | 0 | — | ∘ | 3.9 × 10¹² | 0.94 | ∘ |
| 13* | 10 | 6.9 | ∘ | 9.3 × 10⁹ | 1.11 | ∘ |
| 14 | 20 | 6.9 | ∘ | 7.9 × 10⁹ | 1.18 | ∘ |
| 15 | 40 | 6.9 | ∘ | 3.3 × 10⁹ | 1.22 | ∘ |
| 16 | 50 | 6.9 | ∘ | 1.0 × 10⁹ | 1.16 | ∘ |
| 17* | 60 | 6.9 | ∘ | 5.8 × 10⁹ | 1.14 | ∘ |
| 18* | 70 | 6.9 | ∘ | 7.9 × 10⁹ | 1.10 | ∘ |
| 19* | 80 | 6.9 | ∘ | 2.6 × 10¹⁰ | 1.00 | ∘ |
| 20 | 30 | 20.0 | ∘ | 1.3 × 10¹⁰ | 1.17 | ∘ |
| 21 | 30 | 13.6 | ∘ | 3.1 × 10⁹ | 1.15 | ∘ |
| 22 | 30 | 10.8 | ∘ | 5.9 × 10⁹ | 1.18 | ∘ |
| 23 | 30 | 8.2 | ∘ | 5.2 × 10⁹ | 1.23 | ∘ |
| 24 | 30 | 4.5 | ∘ | 1.0 × 10⁸ | 1.15 | ∘ |
| 25* | 30 | 2.9 | x | 4.1 × 10⁹ | 1.08 | ∘ |
| 26* | 30 | 1.5 | ∘ | 2.6 × 10⁹ | 0.97 | ∘ |
| 27 | 30 | 13.3 | ∘ | 1.6 × 10¹⁰ | 1.16 | ∘ |
| 28 | 30 | 13.3 | ∘ | 2.0 × 10¹⁰ | 1.16 | ∘ |

Mark“*” indicates a sample out of the present disclosure

In sample No. 1, Cr was not contained in the second alloy powder, and therefore it was found that the sample surface was discolored when sample No. 1 was left for a long period under high humidity, and sample No. 1 was inferior in corrosion resistance and also inferior in insulating property because of specific resistance being as low as 4.0×10⁷ Ω·m.

In sample No. 2, Cr was contained in the second alloy powder, but its content was as low as 0.1 at %, and therefore it was found that the sample was inferior in corrosion resistance.

In sample Nos. 9 to 11, the Cr content of the second alloy powder was 5 at %, but the Cr content of the first alloy powder was as high as 1 to 10 at %, and therefore it was found that the saturation magnetic flux density was as low as 0.85 to 1.14 T and the magnetic characteristics were deteriorated.

In sample No. 12, the second alloy powder was not contained, so that voids were formed between the first alloy powders and the filling property was lowered, and therefore it was found that the saturation magnetic flux density was as low as 0.94 T.

In sample No. 13, the volume content of the second alloy powder was 10 vol % and the first alloy powder having a large median diameter D₅₀ was excessively contained, so that the filling property could not be improved because of void formation in the sample, and therefore it was found that the magnetic flux saturation density Bs was as low as 1.11 T.

In sample Nos. 17 to 19, the volume content of the second alloy powder was 60 to 80 vol % and the volume ratio of the second alloy powder having a small median diameter D₅₀′ was large, so that also in this case, the filling property could not be improved, and therefore it was found that the magnetic flux saturation density Bs was as low as 1.00 to 1.14.

In sample Nos. 25 and 26, the median diameter ratios D₅₀/D₅₀′ were as small as 2.9 and 1.5, respectively, and therefore it was found that the filling property was lowered and voids were easily formed, and the saturation magnetic flux density was as low as 0.97 to 1.08 T. In particular, in sample No. 25, the median diameter D₅₀ of the first alloy powder was also as small as 14 μm, and therefore the corrosion resistance was also deteriorated.

In contrast, in sample Nos. 3 to 8, 14 to 16, 20 to 24, 27 and 28, the Cr content of the first alloy powder having a large median diameter D₅₀ was 0.3 at % or less, the Cr content of the second alloy powder having a small median diameter D₅₀′ was 0.3 to 14 at %, the content of the second alloy powder in the mixed powder was 20 to 50 vol %, the median diameter ratio D₅₀/D₅₀′ was 4 to 20, and all of these values were within the scope of the present disclosure, and therefore it was found that it is possible for each sample to have good corrosion resistance and core loss, good insulation resistance with a specific resistance of 1.0×10⁸ to 2.0×10¹⁰ Ω·m, and good magnetic characteristics with a magnetic flux saturation density Bs of 1.15 to 1.23 T.

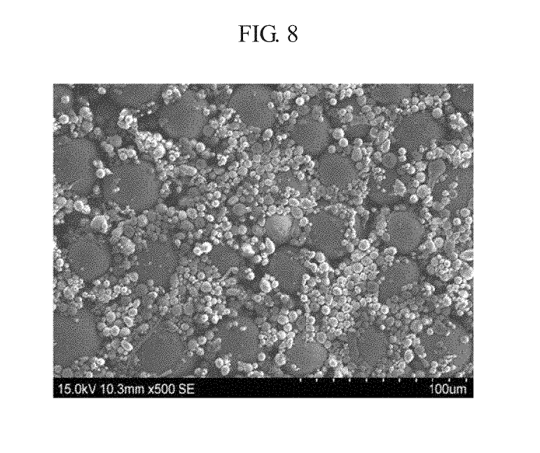

FIG. 8 is a Scanning Electron Microscope (SEM) image of sample No. 6 imaged by the SEM.

As shown in FIG. 8, it was found that the second alloy particles having the small median diameter D₅₀′ were arranged around the first alloy powder in such a manner as to fill the voids formed between the first alloy powder having the large median diameter D₅₀.

### Example 2

Various powders in which a part of Fe in the Fe—Si—B—P-based material was substituted with a predetermined amount of Ni, Co, or Cu, and various powders in which a part of B was substituted with C were prepared in the same manner and procedure as in Example 1, and used as the first alloy powder. Further, Fe₈₁Si₁₁Cr₈ and Fe₇₇Si₈B₉P₄C₁Cr₁ were prepared in the same method and procedure as in Example 1, and this was used as the second alloy powder.

Next, with respect to these first and second alloy powders, as with Example 1, the median diameters D₅₀ and D₅₀′ were measured, and the X-ray diffraction spectrum was measured to identify the powder structural phases. Subsequently, the first and second alloy powders were weighed and mixed so that the volume content of the second alloy powder was the volume ratio as shown in Table 4, and the samples of samples No. 31 to 48 were prepared in the same manner and procedure as in Example 1.

Next, specific resistance and saturation magnetic flux density were measured by the same method and procedure as in Example 1, and corrosion resistance and core loss were evaluated.

Tables 3 and 4 show the component composition and measurement results of sample Nos. 31 to 48.

TABLE 3

| | The first alloy powder | | | The second alloy powder | | |
|---|---|---|---|---|---|---|
| | | Median | | | Median | |
| | | diameter | | | diameter | |
| Sample | | D₅₀ | Identified | | D′₅₀ | Identified |
| No. | Composition | (μm) | phase | Composition | (μm) | phase |
| 31 | Fe₇₀Ni₆Si₉B₁₀P₅ | 48 | amorphous | Fe₈₁Si₁₁Cr₈ | 4.9 | crystalline |
| 32 | Fe₆₄Ni₁₂Si₉B₁₀P₅ | 54 | amorphous | Fe₈₁Si₁₁Cr₈ | 4.9 | crystalline |
| 33 | Fe₇₀Co₆Si₉B₁₀P₅ | 39 | amorphous | Fe₈₁Si₁₁Cr₈ | 4.9 | crystalline |
| 34 | Fe₆₄Co₁₂Si₉B₁₀P₅ | 35 | amorphous | Fe₈₁Si₁₁Cr₈ | 4.9 | crystalline |
| 35* | Fe_{75.3}Si₉B₁₀P₅Cu_{0.7} | 37 | amorphous | — | — | — |
| 36* | Fe_{75.3}Si₉B₁₀P₅Cu_{0.7} | 37 | amorphous | Fe₈₁Si₁₁Cr₈ | 4.9 | crystalline |
| 37 | Fe_{75.3}Si₉B₁₀P₅Cu_{0.7} | 37 | amorphous | Fe₈₁Si₁₁Cr₈ | 4.9 | crystalline |
| 38 | Fe_{75.3}Si₉B₁₀P₅Cu_{0.7} | 37 | amorphous | Fe₈₁Si₁₁Cr₈ | 4.9 | crystalline |
| 39 | Fe_{75.3}Si₉B₁₀P₅Cu_{0.7} | 37 | amorphous | Fe₈₁Si₁₁Cr₈ | 4.9 | crystalline |
| 40 | Fe_{75.3}Si₉B₁₀P₅Cu_{0.7} | 37 | amorphous | Fe₈₁Si₁₁Cr₈ | 4.9 | crystalline |
| 41* | Fe_{75.3}Si₉B₁₀P₅Cu_{0.7} | 37 | amorphous | Fe₈₁Si₁₁Cr₈ | 4.9 | crystalline |
| 42* | Fe_{75.3}Si₉B₁₀P₅Cu_{0.7} | 37 | amorphous | Fe₈₁Si₁₁Cr₈ | 4.9 | crystalline |
| 43* | Fe_{75.3}Si₉B₁₀P₅Cu_{0.7} | 37 | amorphous | Fe₈₁Si₁₁Cr₈ | 4.9 | crystalline |
| 44 | Fe_{75.3}Si₉B₁₀P₅Cu_{0.7} | 38 | amorphous | Fe₈₁Si₁₁Cr₈ | 4.9 | crystalline |
| 45 | Fe_{74.5}Si₉B₁₀P₅Cu_{1.5} | 51 | amorphous | Fe₈₁Si₁₁Cr₈ | 4.9 | crystalline |
| 46 | Fe₇₆Si₉B₈C₂P₅ | 41 | amorphous | Fe₈₁Si₁₁Cr₈ | 4.9 | crystalline |
| 47 | Fe₇₆Si₉B₆C₄P₅ | 44 | amorphous | Fe₈₁Si₁₁Cr₈ | 4.9 | crystalline |
| 48 | Fe₇₆Si₉B₆C₄P₅ | 44 | amorphous | Fe₇₇Si₈B₉P₄C₁Cr₁ | 3.3 | crystalline |

Mark“*” indicates a sample out of the present disclosure

TABLE 4

| | Volume | | | | | |
|---|---|---|---|---|---|---|
| | content | | | | | |
| | of the | | | | Saturation | |
| | second | Median | | | magnetic | |
| | alloy | diameter | | | flux | |
| Sample | powder | ratio | Corrosion | Resistivity | density | Core |
| No. | (vol %) | (D₅₀/D′₅₀) | resistance | (Ω · m) | (T) | loss |
| 31 | 30 | 9.9 | ∘ | 6.0 × 10⁹ | 1.19 | ∘ |
| 32 | 30 | 11.0 | ∘ | 5.6 × 10⁹ | 1.22 | ∘ |
| 33 | 30 | 8.0 | ∘ | 9.3 × 10⁹ | 1.23 | ∘ |
| 34 | 30 | 7.1 | ∘ | 4.8 × 10⁹ | 1.22 | ∘ |
| 35* | 0 | — | ∘ | 1.2 × 10¹² | 0.93 | ∘ |
| 36* | 10 | 7.6 | ∘ | 2.2 × 10¹⁰ | 1.10 | ∘ |
| 37 | 20 | 7.6 | ∘ | 6.7 × 10⁹ | 1.17 | ∘ |
| 38 | 30 | 7.6 | ∘ | 4.5 × 10⁹ | 1.20 | ∘ |
| 39 | 40 | 7.6 | ∘ | 1.8 × 10⁹ | 1.21 | ∘ |
| 40 | 50 | 7.6 | ∘ | 4.9 × 10⁹ | 1.15 | ∘ |
| 41* | 60 | 7.6 | ∘ | 6.3 × 10⁹ | 1.12 | ∘ |
| 42* | 70 | 7.6 | ∘ | 8.4 × 10¹⁰ | 1.08 | ∘ |
| 43* | 80 | 7.6 | ∘ | 1.9 × 10¹¹ | 1.02 | ∘ |
| 44 | 30 | 7.7 | ∘ | 8.1 × 10⁹ | 1.21 | ∘ |
| 45 | 30 | 10.4 | ∘ | 2.9 × 10⁹ | 1.18 | ∘ |
| 46 | 30 | 8.4 | ∘ | 4.1 × 10⁹ | 1.18 | ∘ |
| 47 | 30 | 9.0 | ∘ | 1.8 × 10⁹ | 1.18 | ∘ |
| 48 | 30 | 13.3 | ∘ | 1.4 × 10¹⁰ | 1.15 | ∘ |

Mark“*” indicates a sample out of the present disclosure

In sample No. 35, as with sample No. 12, the second alloy powder was not contained, so that voids were formed between the first alloy powders and the filling property was lowered, and therefore it was found that the saturation magnetic flux density was as low as 0.93 T.

In sample No. 36, as with sample No. 13, the volume content of the second alloy powder was 10 vol % and the volume ratio of the first alloy powder having a large median diameter D₅₀ was large, so that the filling property could not be improved because of void formation in the sample, and therefore it was found that the magnetic flux saturation density Bs was as low as 1.10 T.

In sample Nos. 41 to 43, as with sample Nos. 17 to 19, the volume content of the second alloy powder was 60 to 80 vol % and the volume ratio of the second alloy powder having a small median diameter D₅₀′ was large, and therefore it was found that the magnetic flux saturation density Bs was as low as 1.02 to 1.12.

In contrast, in sample Nos. 31 to 34, 37 to 40, and 44 to 48, the Cr content of the first alloy powder having a large median diameter D₅₀ was 0.3 at % or less, the Cr content of the second alloy powder having a small median diameter D₅₀′ was 0.3 to 14 at %, the content of the second alloy powder in the mixed powder was 20 to 50 vol %, the median diameter ratio D₅₀/D₅₀′ was 4 to 20, and all of these values were within the scope of the present disclosure, and therefore it was found that it is possible for each sample to have good corrosion resistance and core loss, good insulation resistance with a specific resistance of 1.8×10⁹ to 1.4×10¹⁰ Ω·m, and good magnetic characteristics with a magnetic flux saturation density Bs of 1.15 to 1.23 T.

That is, it was confirmed that good results could be obtained as with Example 1 even when a part of Fe in the Fe—Si—B—P-based material was substituted with Ni or Co within the range of 12 at % or less or substituted with Cu within the range of 1.5 at % or less, or a part of B was substituted with C within the range of 4 at % or less.

### Example 3

As base materials for a first alloy powder, Fe, Si, B, Fe₃P, and Cu were prepared. Then, these base materials were weighed and mixed so that the composition formula was Fe_{79.5}Si₆B₆P₈Cu_{0.5}. Subsequently, the mixed product was heated and melted at a temperature higher than the melting point in a high frequency induction furnace, and then the melted product was poured into a casting mold made of copper, followed by cooling, so that a master alloy was prepared.

Next, as with Example 1, synthesized materials was obtained using a gas atomization method. The median diameter D₅₀ of the synthesized materials was measured with the above-mentioned particle diameter distribution analyzer, and consequently the median diameter was 37 μm.

An X-ray spectrum of each of the synthesized materials was measured in the same manner and procedure as in Example 1, and consequently it was confirmed that the powder structure phase was an amorphous phase. Next, the synthesized materials each were heat-treated at different temperatures in the range of 400° C. to 500° C. for 5 minutes, so that first alloy powders of sample Nos. 51 to 55 were prepared. The X-ray diffraction spectrum of each of the first alloy powders of sample Nos. 51 to 55 was measured in the same manner as described above, and consequently it was confirmed that the powder structure phase changed from an amorphous phase to a crystalline phase.

Next, the average crystallite diameter D of each of the first alloy powders of sample Nos. 51 to 55 was determined by the following method. That is, the average crystallite size D can be expressed by the Scherrer equation shown by the formula (1). D=Kλ/B cos θ(1).

In the formula, B represents the full width at half maximum (hereinafter, referred to as “FWHM”) in the vicinity of the (110) diffraction peak of α-Fe (ferrite phase), λ represents the characteristic X-ray used for the measurement, i.e., the wavelength of CuKα (=0.1540538 nm), and θ represents the diffraction peak position (=22.35°). K represents the shape factor.

Then, the FWHM was measured from the X-ray diffraction profile, and the FWHM was substituted into the above formula (1) to obtain the crystallite diameter D. As the shape factor K, 0.94 that is simply used in the case of the α-Fe phase as a body-centered cubic structure was used.

In addition, as the second alloy powder, Fe₈₁Si₁₁Cr₈ used in Example 1 was prepared. Subsequently, the first alloy powder and the second alloy powder were mixed so that the volume content of the second alloy powder was 30 vol %, and in the same manner and procedure as in Example 1, each of samples of sample Nos. 51 to 55 was prepared. Next, specific resistance and saturation magnetic flux density were measured by the same method and procedure as in Example 1, and corrosion resistance and core loss were evaluated.

Tables 5 and 6 show the component composition and measurement results of sample Nos. 51 to 55.

TABLE 5

| | The first alloy powder | | | | The second alloy powder | | | |
|---|---|---|---|---|---|---|---|---|
| | | Median | | Average | | Median | | Heat |
| | | diameter | | crystallite | | diameter | | treating |
| Sample | | D₅₀ | Identified | size | | D′₅₀ | Identified | temperature |
| No. | Composition | (μm) | phase | (nm) | Composition | (μm) | phase | (° C.) |
| 51 | Fe_{79.5}Si₆B₆P₈Cu_{0.5} | 37 | crystalline | 19 | Fe₈₁Si₁₁Cr₈ | 4.9 | crystalline | 400 |
| 52 | Fe_{79.5}Si₆B₆P₈Cu_{0.5} | 37 | crystalline | 23 | Fe₈₁Si₁₁Cr₈ | 4.9 | crystalline | 425 |
| 53 | Fe_{79.5}Si₆B₆P₈Cu_{0.5} | 37 | crystalline | 47 | Fe₈₁Si₁₁Cr₈ | 4.9 | crystalline | 450 |
| 54* | Fe_{79.5}Si₆B₆P₈Cu_{0.5} | 37 | crystalline | 60 | Fe₈₁Si₁₁Cr₈ | 4.9 | crystalline | 475 |
| 55* | Fe_{79.5}Si₆B₆P₈Cu_{0.5} | 37 | crystalline | 65 | Fe₈₁Si₁₁Cr₈ | 4.9 | crystalline | 500 |

Mark“*” indicates a sample out of the present disclosure

TABLE 6

| | Volume | | | | | |
|---|---|---|---|---|---|---|
| | content of | | | | Saturation | |
| | the second | Median | | | magnetic | |
| | alloy | diameter | | | flux | |
| Sample | powder | ratio | Corrosion | Resistivity | density | Core |
| No. | (vol %) | (D₅₀/D′₅₀) | resistance | (Ω · m) | (T) | loss |
| 51 | 30 | 7.6 | 0 | 2.9 × 10⁹ | 1.28 | ∘ |
| 52 | 30 | 7.6 | 0 | 2.9 × 10⁹ | 1.26 | ∘ |
| 53 | 30 | 7.6 | 0 | 2.9 × 10⁹ | 1.29 | ∘ |
| 54* | 30 | 7.6 | 0 | 2.9 × 10⁹ | 1.30 | x |
| 55* | 30 | 7.6 | 0 | 2.9 × 10⁹ | 1.30 | x |

Mark“*” indicates a sample out of the present disclosure

In sample Nos. 54 and 55, the heat treatment temperature was as high as 475 to 500° C., and therefore the average crystallite diameter increased to 60 nm and 67 nm, respectively, the coercive force could not be lowered and the core loss increased. In contrast, in sample Nos. 51 to 53, the average crystallite diameter was 19 to 47 nm, which was as small as 50 nm or less, and therefore it was found that the coercive force could be lowered and a coil component having a low core loss could be obtained.

It is possible to realize a magnetic powder with good corrosion resistance and low magnetic loss without damaging insulation resistance and saturation magnetic flux density, and a coil component using the magnetic powder such as a magnetic core and an inductor.

What is claimed is:

1. A magnetic powder comprising a plurality of alloy powders including at least a first alloy powder and a second alloy powder in which those composition are different,
wherein
the second alloy powder has an average particle diameter smaller than an average particle diameter of the first alloy powder and contains Cr in a range of 0.3 to 14 at % in terms of atomic ratio;
a content of Cr of the first alloy powder is 0.3 at % or less in terms of atomic ratio;
with respect to a total sum of the first alloy powder and the second alloy powder, a content of the second alloy powder is 20 to 50 vol % in terms of volume ratio, and a ratio of the average particle diameter of the first alloy powder to the average particle diameter of the second alloy powder is 4 to 20; and
the first alloy powder includes at least any one of an amorphous phase and a crystalline phase having an average crystallite size of 50 nm or less.

2. The magnetic powder according to claim 1, wherein the first alloy powder contains a Fe—Si—B—P-based material as a main component.

3. The magnetic powder according to claim 2, wherein in the first alloy powder, a part of Fe in the Fe—Si—B—P-based material is substituted with any one element of Ni and Co in a range of 12 at % or less.

4. The magnetic powder according to claim 2, wherein in the first alloy powder, a part of Fe in the Fe—Si—B—P-based material is substituted with Cu in a range of 1.5 at % or less.

5. The magnetic powder according to claim 2, wherein in the first alloy powder, a part of B in the Fe—Si—B—P-based material is substituted with C in a range of 4 at % or less.

6. The magnetic powder according to claim 1, wherein the first alloy powder is prepared by a gas atomization method.

7. The magnetic powder according to claim 1, wherein the second alloy powder includes any one of an amorphous phase and a crystalline phase.

8. The magnetic powder according to claim 1, wherein the second alloy powder contains a Fe—Si—Cr-based material as a main component.

9. The magnetic powder according to claim 8, wherein in the second alloy powder, the Fe—Si—Cr-based material contains at least one element selected from the group consisting of B, P, C, Ni and Co.

10. The magnetic powder according to claim 1, wherein the second alloy powder is prepared by a water atomization method.

11. A method for producing a magnetic powder containing at least a first alloy powder and a second alloy powder in which those composition and average particle diameter are different, the method comprising:
preparing the first alloy powder by weighing and mixing predetermined base materials, heating the mixed product to prepare a molten metal, and spraying an inert gas on the molten metal to pulverize the molten metal and to prepare an amorphous powder;
preparing the second alloy powder by weighing and mixing predetermined base materials containing Cr so as to contain the Cr in a range of 0.3 to 14 at % in terms of atomic ratio, heating the mixed product to prepare a molten metal, and spraying water on the molten metal to pulverize the molten metal and to obtain a second alloy powder in which an average particle diameter ratio between an average particle diameter of the first alloy powder and an average particle diameter of the second alloy powder is 4 to 20;
the amorphous powder is used as the first alloy powder, and the first alloy powder and the second alloy powder are mixed so that, with respect to a total sum of the first alloy powder and the second alloy powder, a content of the second alloy powder is 20 to 50 vol % in terms of volume ratio, to prepare a magnetic powder.

12. The method for producing a magnetic powder according to claim 11, wherein
the preparing the first alloy powder includes heat treating the amorphous powder prepared in the spraying the inert gas to prepare a crystalline powder having an average crystallite size of 50 nm or less,
the crystalline powder is used as the first alloy powder in place of the amorphous powder, and the first alloy powder and the second alloy powder are mixed so that, with respect to the total sum of the first alloy powder and the second alloy powder, the content of the second alloy powder is 20 to 50 vol % in terms of volume ratio, to prepare a magnetic powder.

13. The method for producing a magnetic powder according to claim 12, wherein the average crystallite size varies depending on a heat treatment temperature during the heat treatment.

14. The method for producing a magnetic powder according to claim 11, wherein in the spraying the inert gas, a mixed gas formed by adding hydrogen gas to the inert gas is sprayed on the molten metal.

15. The method for producing a magnetic powder according to claim 11, wherein the inert gas is any one of an argon gas and a nitrogen gas.

16. A magnetic core comprising a composite material of the magnetic powder according to claim 1 and a resin powder as a main component.

17. The magnetic core according to claim 16, wherein a content of the magnetic powder in the composite material is 60 to 90 vol % in terms of volume ratio.

18. A method for producing a magnetic core, comprising:
mixing a magnetic powder prepared by the method for producing according to claim 11 with a resin powder and subjecting a resulting mixture to forming treatment to prepare a compact; and
heat treating the compact.

19. A coil component comprising a coil conductor wound around a core part, wherein the core part is formed of the magnetic core according to claim 16.

20. A coil component comprising a coil conductor buried in a magnetic part, wherein a main component of the magnetic part is predominantly composed of a composite material containing the magnetic powder according to claim 1 and a resin powder.

21. The coil component according to claim 20, wherein in the magnetic part, a content of the magnetic powder in the composite material is 60 to 90 vol % in terms of volume ratio.
